(19) United States
(12) Patent Application Publication
(10) Pub. No.: US 2025/0291554 A1
(43) Pub. Date: Sep. 18, 2025

(54) VALIDATING REUSABLE CODE FOR A LANGUAGE MODEL-BASED NETWORK AGENT

(71) Applicant: Cisco Technology, Inc., San Jose, CA (US)

(72) Inventors: Eduard Schornig, Haarlem (NL); Grégory Mermoud, Venthône (CH); Jean-Philippe Vasseur, Combloux (FR); Pierre-André Savalie, Rueil-Malmaison (FR)

(73) Assignee: Cisco Technology, Inc., San Jose, CA (US)

(21) Appl. No.: 18/606,201

(22) Filed: Mar. 15, 2024

(51) Int. Cl. G06F 8/33; G06F 11/36

(52) U.S. Cl. CPC G06F 8/33; G06F 11/3604

(57) ABSTRACT

In one implementation, a device obtains code generated by a language model-based agent to perform an action of a particular type with respect to a computer network. The device determines one or more parameters to execute the code in a testing environment. The device performs a validation assessment of the code to assess whether it is able to perform actions of the particular type by executing it with the one or more parameters in the testing environment. The device makes, based on the validation assessment, the code available to the language model-based agent to perform a subsequent action of the particular type.

### TECHNICAL FIELD

The present disclosure relates generally to validating reusable code for a language model-based network agent.

### BACKGROUND

The recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

An observation herein is that one potential way to conserve resources in an LLM-based network agent would be to reuse any code that the agent previously generated to perform a certain type of action. However, doing so also runs the risk of the agent repeating the same mistakes over and over again. Indeed, LLMs are not infallible and are subject to conditions, such as hallucinations, which lead the LLM to generate code that is unable to perform the desired task successfully (e.g., by retrieving the wrong information, by using the wrong syntax, etc.). Without a framework to validate the reusable code, any mechanism to allow an LLM-based agent to reuse code would be largely unreliable, making deployment of that mechanism unlikely in a production environment.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIG. 4 illustrates an example software defined network (SDN) implementation;

FIG. 5 illustrates an example architecture for teaching a large language model (LLM)-based agent to troubleshoot networks using reinforcement learning;

FIG. 6 illustrates an example action definition;

FIG. 7 illustrates an example action tree;

FIG. 8 illustrates an example of the interactions of the components of the architecture in FIG. 5;

FIG. 9 illustrates an example architecture for an agent training framework;

FIGS. 10A-10D illustrate example policy strategies;

FIG. 11 illustrates an example of an agent generating code to perform an action;

FIG. 12 illustrates an example architecture for validating code generated by a language model-based agent;

FIGS. 13A-13B illustrate examples of performing a validation assessment of generated code; and

FIG. 14 illustrates an example simplified procedure for validating reusable code for a language model-based network agent.

### DESCRIPTION OF EXAMPLE IMPLEMENTATIONS

### Overview

According to one or more implementations of the disclosure, a device obtains code generated by a language model-based agent to perform an action of a particular type with respect to a computer network. The device determines one or more parameters to execute the code in a testing environment. The device performs a validation assessment of the code to assess whether it is able to perform actions of the particular type by executing it with the one or more parameters in the testing environment. The device makes, based on the validation assessment, the code available to the language model-based agent to perform a subsequent action of the particular type.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

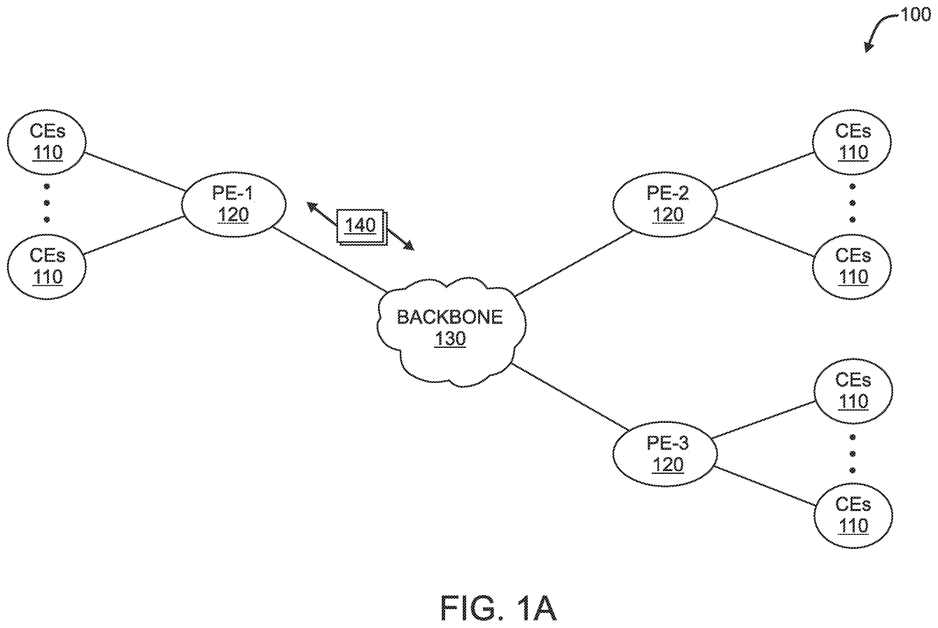

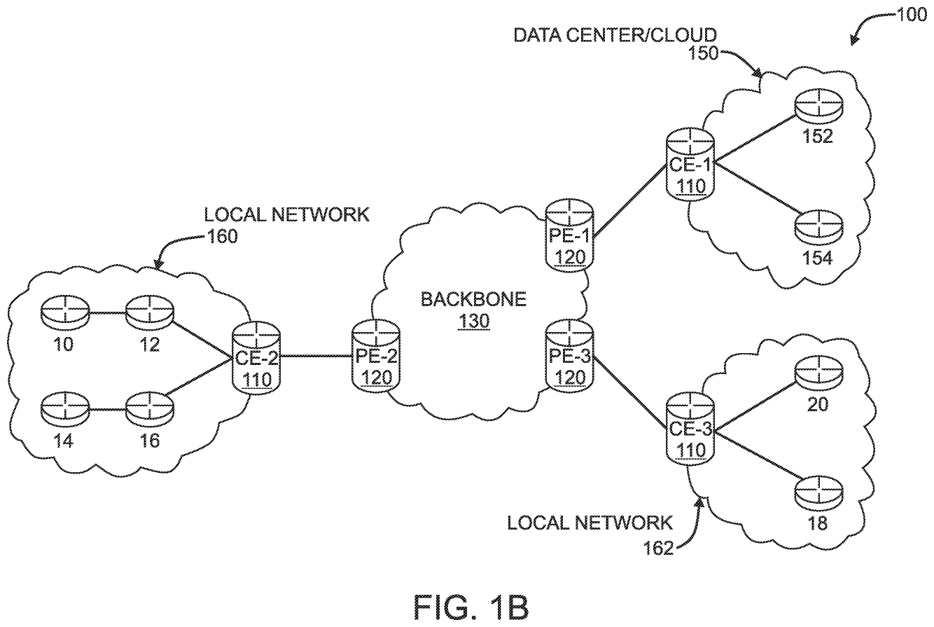

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection). Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

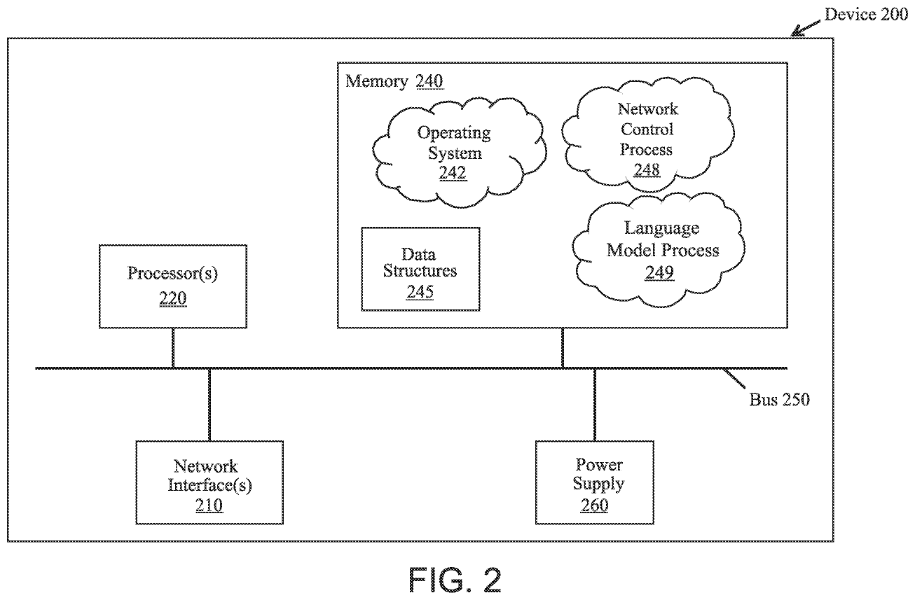

FIG. 2 is a schematic block diagram of an example node/device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise a network control process 248 and/or a language model process 249 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In some instances, network control process 248 may include computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, network control process 248 may consist solely of providing mechanisms necessary for source routing techniques. That is, for source routing, other devices in the network can tell the less capable devices exactly where to send the packets, and the less capable devices simply forward the packets as directed.

In various implementations, as detailed further below, network control process 248 and/or language model process 249 may include computer executable instructions that, when executed by processor(s) 220, cause device 200 to perform the techniques described herein. To do so, in some implementations, network control process 248 and/or language model process 249 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, network control process 248 and/or language model process 249 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that network control process 248 and/or language model process 249 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, network control process 248 and/or language model process 249 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, network control process 248 may use a generative model to generate synthetic network traffic based on existing user traffic to test how the network reacts. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

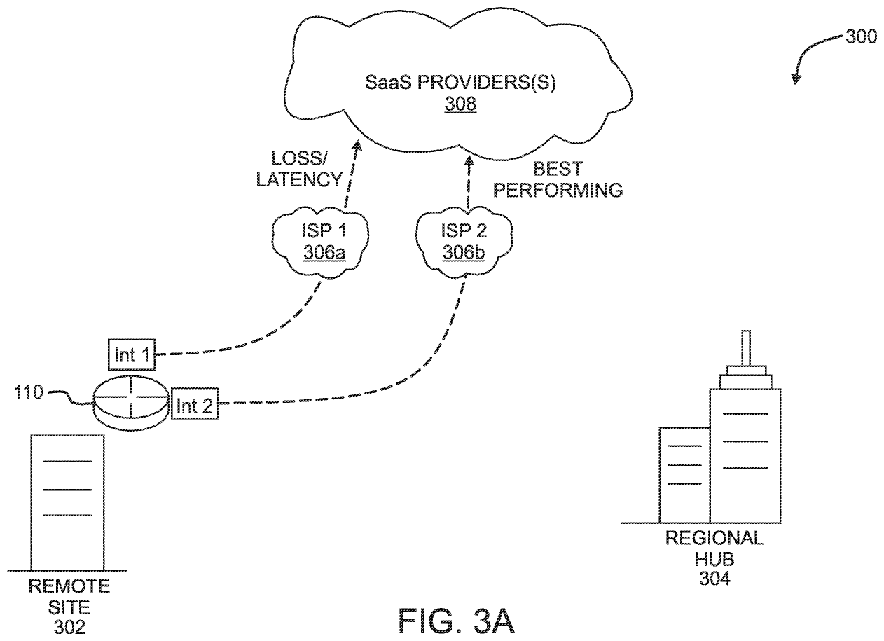

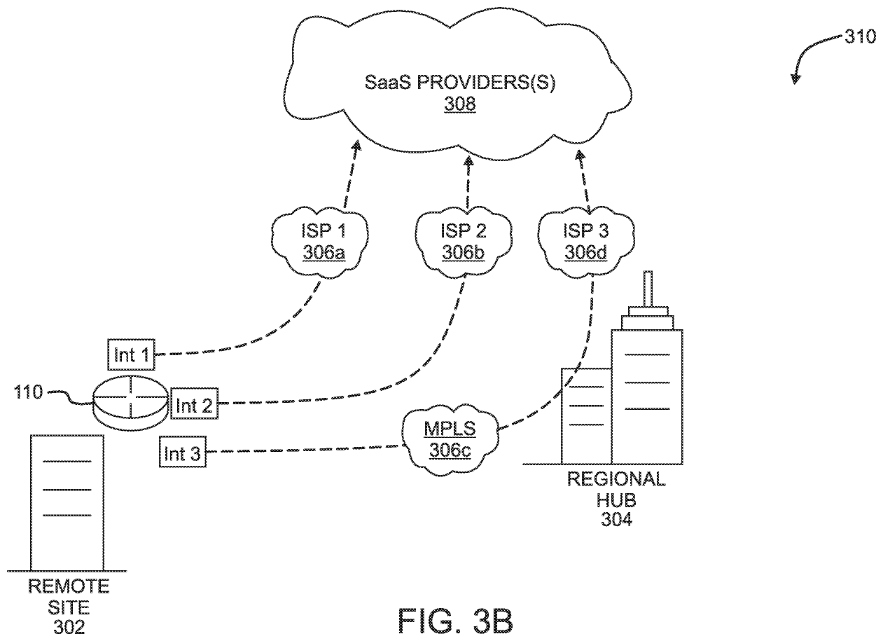

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g, ADSL, 4G, 5G, etc) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

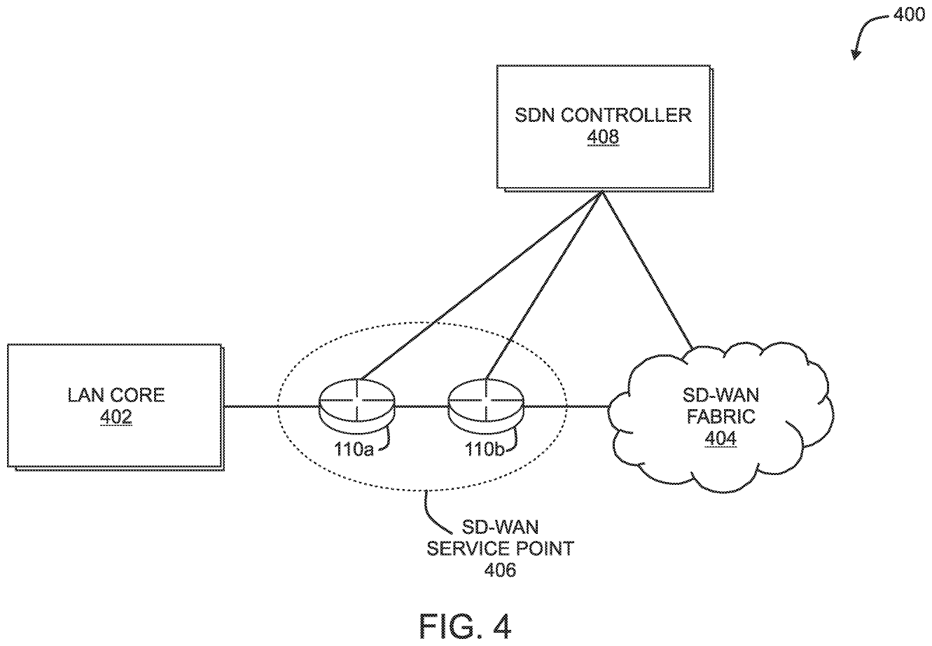

FIG. 4 illustrates an example SDN implementation 400, according to various implementations. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service (e.g., through execution of network control process 248), typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions,
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various implementations, SDN controller 408 may employ application aware routing, which refers to the ability to route traffic so as to satisfy the requirements of the application, as opposed to exclusively relying on the (constrained) shortest path to reach a destination IP address. For instance, SDN controller 408 may make use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, SDN controller 408 may compute a variety of models to understand application requirements, and predictably route traffic over private networks and/or the Internet, thus optimizing the application experience while drastically reducing SLA failures and downtimes.

In other words, SDN controller 408 may first predict SLA violations in the network that could affect the QoE of an application (e.g., due to spikes of packet loss or delay, sudden decreases in bandwidth, etc.). In other words, SDN controller 408 may use SLA violations as a proxy for actual QoE information (e.g., ratings by users of an online application regarding their perception of the application), unless such QoE information is available from the provider of the online application. In turn, SDN controller 408 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one implementation. In general, routing configuration changes are also referred to herein as routing “patches,” which are typically temporary in nature (e.g., active for a specified period of time) and may also be application-specific (e.g., for traffic of one or more specified applications).

As noted above, the recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc.

In the specific context of computer networks, though, network troubleshooting and monitoring are traditionally complex tasks that rely on engineers analyzing telemetry data, configurations, logs, and events across a diverse array of network devices encompassing access points, firewalls, routers, and switches managed by various types of network controllers (e.g., SD-WAN, DNAC, ACI, etc.). Moreover, network issues can manifest in various forms, stemming from a multitude of factors, each with its own level of complexity.

The easiest way to build an LLM-based network troubleshooting agent would be to utilize the zero-shot capabilities of the model (or few-shot using some examples in the prompt). For instance, one might prompt GPT-4 with some description of the problem and some instruction(s) to solve the problem. More elaborate approaches might include allowing the model to write code to fetch data through controller application programming interfaces (APIs) (e.g., DNA Center, vManage, Intersight, etc.) and then form an answer based on this extra data. In such a case, one must provide some form of API documentation to the model through retrieval-augmented generation (RAG), by fetching relevant documents from a vector database and including them in the prompt.

However, these approaches are limited in that they do not learn from past experiences: whether they fail or succeed in solving a user request, they will have the same likelihood of succeeding on a similar question. In addition, they require very capable (and therefore very large) models: because they rely on zero-shot capabilities, they require models with strong reasoning and coding abilities.

### Teaching Language Model-Based Agents to Troubleshoot Network Issues

The techniques herein introduce an architecture that addresses the above challenges through the use of reinforcement learning, whereby an LLM-or other language model-based agent is trained to take actions in a rich environment whereby a vast number of actions can be taken to maximize a notion of cumulative reward. More specifically, the architecture herein allows the agent to learn to interact with a network, to identify the root cause of an issue in the network and ultimately solve that issue.

Illustratively, the techniques described herein may be performed by hardware, software, and/or firmware, such as in accordance with language model process 249, which may include computer executable instructions executed by the processor 220 (or independent processor of interfaces 210) to perform functions relating to the techniques described herein, such as in conjunction with network control process 248.

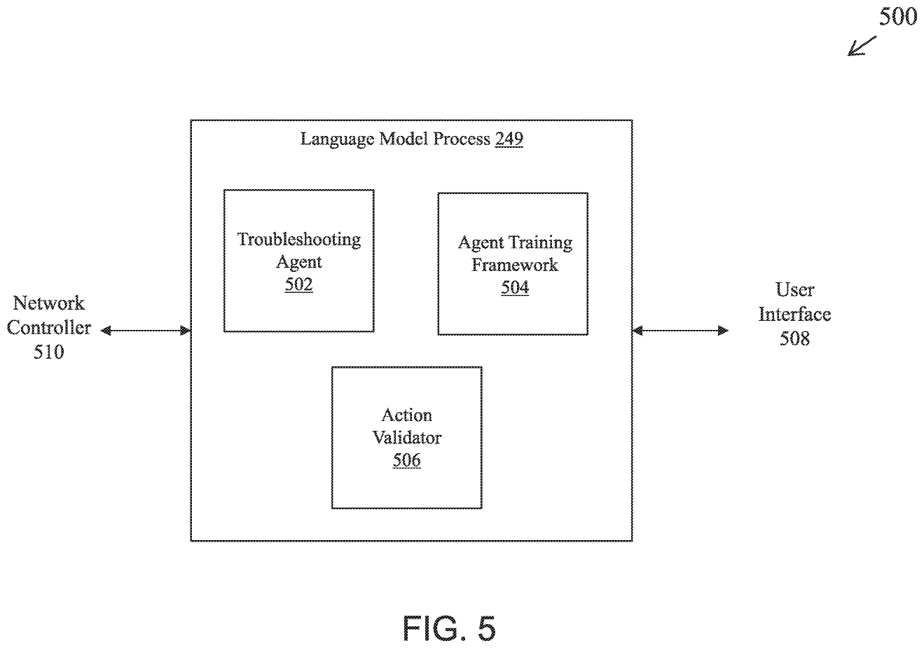

Operationally, FIG. 5 illustrates an example architecture for teaching an LLM-based agent to troubleshoot networks using reinforcement learning, according to various implementations. At the core of architecture 500 is language model process 249, which may be executed by a controller for a network or another device in communication therewith. For instance, language model process 249 may be executed by a controller for a network (e.g., SDN controller 408 in FIG. 4, a network controller in a different type of network, etc.), a particular networking device in the network (e.g., a router, a firewall, etc.), another device or service in communication therewith, or the like. For instance, as shown, language model process 249 may interface with a network controller 510, either locally or via a network, such as via one or more application programming interfaces (APIs), etc. In addition, language model process 249 may communicate with any number of user interfaces, such as user interface 508.

As shown, language model process 249 may include any or all of the following components: a troubleshooting agent 502, an agent training framework 504, and/or an action validator 506. As would be appreciated, the functionalities of these components may be combined or omitted, as desired. In addition, these components may be implemented on a singular device or in a distributed manner, in which case the combination of executing devices can be viewed as their own singular device for purposes of executing language model process 249.

According to various implementations, troubleshooting agent 502 may leverage one or more LLMs to troubleshoot an issue, find the actual root cause for the issue, and/or suggest a set of one or more actions to fix the issue. Let ai denote an action used for troubleshooting an issue I and let Ai denote an action (configuration change) on the network (closed-loop control). In various instances, issue I may be raised by an end user, a set of users, or detected automatically within the network.

The set of actions Ai required to solve the issue I may be determined on-the-fly by the LLM of troubleshooting agent 502, statically determined according to a cookbook for each trajectory made of a set of action ai, or the like. For example, a static cookbook may be used to map a specific ak to set of actions Ak,1. Consider the action ak=“Check the priority queue length of a router,” a static set of action ak,1 may be used to trigger a set of l action on the network (e.g., “Change the weight of the priority queue,” “Modify the WRED parameter for the high priority queue”). In another implementation, the system may discover the set of required actions related to a given root cause identified thanks to a set of action ai, using reinforcement learning or another suitable approach.

If the root cause identified by troubleshooting agent 502 for issue I is eligible for automated action (e.g., according to a policy), troubleshooting agent 502 may perform any or all of the following:

Troubleshooting agent 502 retrieves the set of action Ai for the root cause of issue I after activating a timer T (max time to solve the issue)
Troubleshooting agent 502 may also employ various optimization criterion may be used for solving a given task T. For instance, troubleshooting agent 502 may solve some tasks with objective metrics such as reducing the processing time or improve accuracy even at the risk of involving more steps and tokens (cost). In the context of the techniques herein, the issue criticality may also drive the optimization criteria (e.g., time versus reliability versus cost). In one implementation, the optimization criteria may be unique and decided according to policy and criticality. In another implementation, troubleshooting agent 502 may trigger multiple actions in parallel, each with different optimization criterion. For example, for a given issue I, troubleshooting agent 502 may send a request to a first LLM with a first criteria (e.g., solve as quickly as possible, optimizing time) and send the same request to a second LLM with different optimization criteria (e.g., efficiency). In such a case, troubleshooting agent 502 may use the reply to the first request (set of resolution action Ai) to quickly fix the network, followed by using the second set of actions to optimize the resolution of the issue. Note that both requests may not overlap in terms of closed-loop actions, as well.

As would be appreciated, while troubleshooting agent 502 may be capable of performing complex troubleshooting tasks and, in some instances, taking automated action to correct issues in the network, its general functionality may also include tasks such as simply monitoring the status or performance of the network, as well as performing configuration changes, even in the absence of an existing issue.

In various implementations, troubleshooting agent 502 may utilize reinforcement learning, to improve its performance over time. To do so, troubleshooting agent 502 may perform network troubleshooting, such as by executing Python code in an iterative manner, collecting observations about the network along the way, and attempting to correctly sequence API calls. At the core troubleshooting agent 502 may be one or more models trained using reinforcement learning, which is/are responsible for picking the best action in a given state.

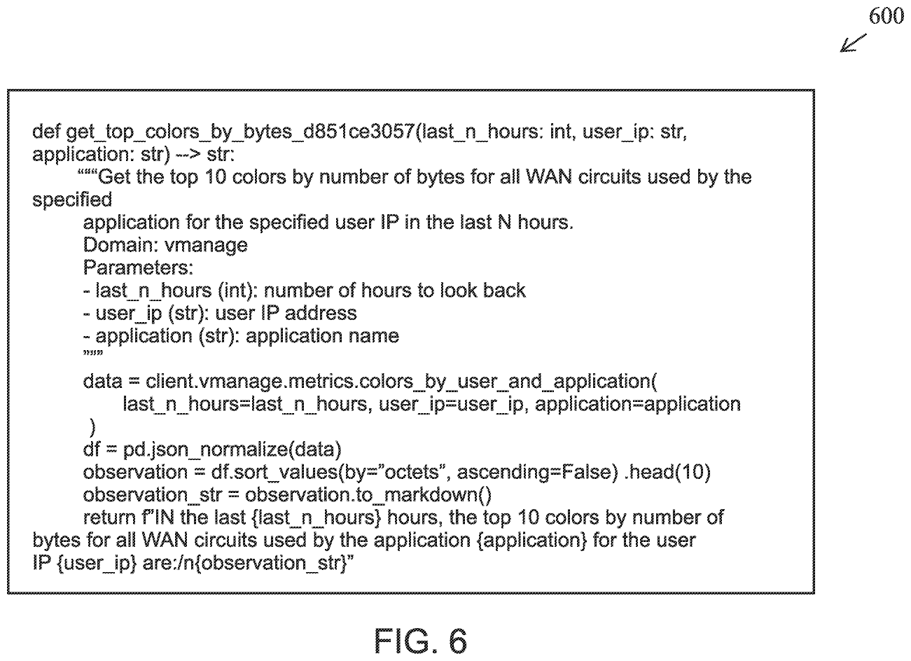

In such cases, the actions described above may be performed by associated code in the form of (Python) functions that take arguments mapped from the observations made so far and return a new observation. By way of example, FIG. 6 illustrates an example action definition 600 written in Python. As shown, each action may have an identifier (e.g., d851ce3057 in definition 600), a name (e.g., get_top_colors_by_bytes), a set of parameters, a domain, and/or description of the resulting observation. Importantly, actions produce observations that may be self-contained, i.e., they contain the parameter values.

Here, observations are facts about the network being troubleshooted, which are accumulated by troubleshooting agent 502 as it executes actions. The state of troubleshooting agent 502 is characterized by the question (i.e., the user's input request) and the observations made so far about the network.

To support reinforcement learning, troubleshooting agent 502 may further be configured as follows:
Actions are constrained: troubleshooting agent 502 is only allowed to perform pre-defined actions, which have been reviewed and curated by experts. However, the generation of these actions is automated, and is part of the learning process. Note that the set of allowed actions may also be governed by task according to a policy.
Sequencing of actions is learned: given a question and a set of observations, the decision as to which action should be executed next is made by a learned policy, which is trained on past questions.
The LLM of troubleshooting agent 502 parses and maps observations to actions: in troubleshooting agent 502, one or more LLMs may also play a secondary role, i.e., parsing the output of actions either to map observations to action arguments or to generate a final answer and handle follow up questions.

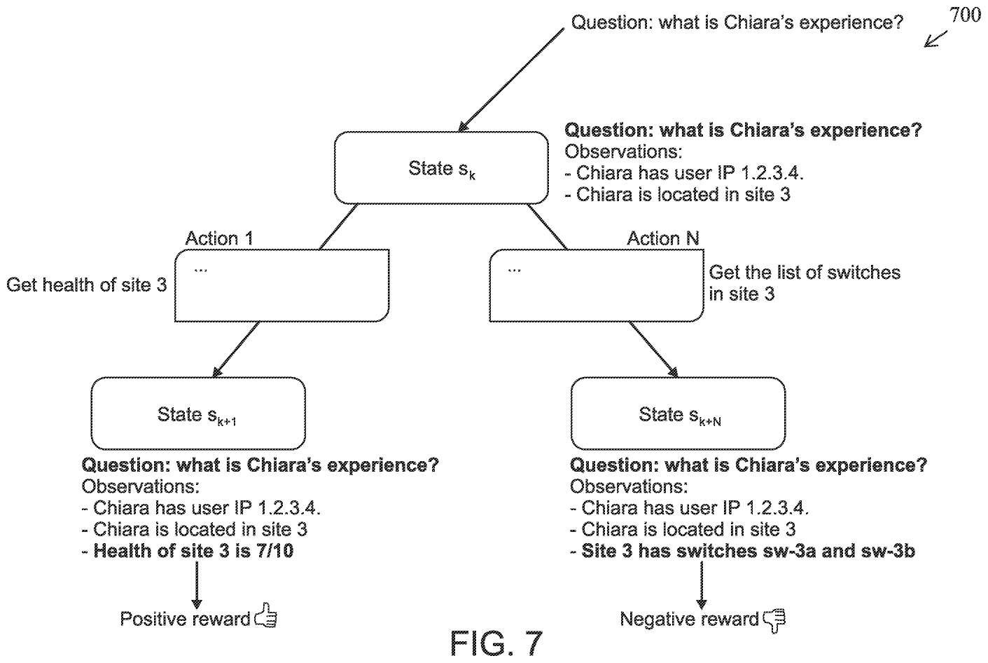

FIG. 7 illustrates an example action tree 700, which represents the sequence of states and actions, ultimately leading to a reward. In general, an effective reinforcement learning strategy builds a so-called policy, which governs which action must be picked by the agent in a given state, so as to maximize the cumulative reward. As shown, the root of an action tree, such as action tree 700 is a question or other troubleshooting task without any observation and each branch is a sequence of the form:

traceⱼ:=s₀^{j}→α₀^{j}→s₁^{j}→ . . . →α^{j}

where s₀^{j} is a state made of only the question and α^{j} is the final answer extracted by troubleshooting agent 502 from the set of observations. Based on this answer, the evaluation framework computes a reward, which is used to train troubleshooting agent 502, refine the set of actions, or both.

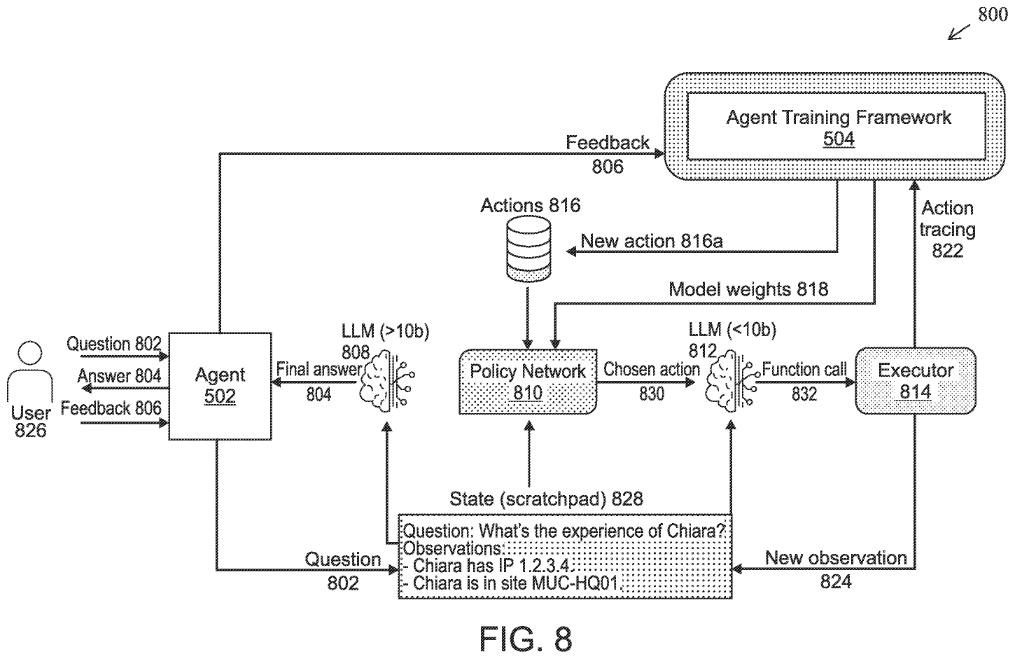

FIG. 8 illustrates an example 800 of the interactions of the components of the architecture in FIG. 5, in various implementations. Note that example 800 illustrates one potential deployment scenario whereby troubleshooting agent 502 is deployed on-prem. In such a case, the model(s) of troubleshooting agent 502 are not updated on-premise, but new weights are regularly pushed from the cloud (e.g., the policy is learned by a central engine). The companion LLMs of troubleshooting agent 502 that perform function calls and produce the final answer based on all observations may be updated as well, although this might not be always the case.

As shown, troubleshooting agent 502 may rely on various models, such as LLM 808, responsible for producing the final answer 804 in response to a question 802 (e.g., an input troubleshooting request) from a user 826. In addition, troubleshooting agent 502 may also leverage a policy network 810 that may take the form of a transformer-based model, but non-generative, that selects a given action. Troubleshooting agent 502 may also use an LLM that is smaller than that of LLM 808, LLM 812, to enact the action selected by policy network 810 using an executor 814. Preferably, these models are able to run on-prem without any need to push data to the cloud, except for the usual telemetry used for serviceability purposes. Alternatively, the models can also run in the cloud when an enterprise prefers not to have an on-premise footprint.

More specifically, the workflow may proceed as follows:
1. A user 826 asks a question 802 to troubleshooting agent 502, which adds it to the state 828 (e.g., a scratchpad). For instance, assume that question 802 asks “what's the experience of Chiara?”
2. Policy network 810 takes state 828 as input and chooses the next action to perform from the set of allowed actions 816. Note that some actions may be selected by the learned policy as the ones with highest potential for future reward or totally new (e.g., based on a notion of exploration).
3. LLM 812 is responsible to take the chosen action 830 and produce a valid function call 832 for execution by executor 814.
4. In turn, executor 814 performs the action and the resulting observation 824 is added to the state. For instance, executor 814 may take the form of a Python shell, read-eval-print loop (REPL), that executes the Python code associated with the chosen action 830.
5. The workflow may return to step 2 above and iterate until the system reaches a point where a final answer 804 can be produced.
6. The final answer 804 is then provided back by LLM 808 or review by user 826.

The decision to stop the iteration and produce a final answer may be taken either by policy network 810 itself, which may produce a specific output to denote that the goal has been reached or by LLM 808, which can decide that the set of observations is sufficient to produce a valid answer.

In some implementations, user 826 may also be able to provide feedback 806 on final answer 804, such as by flagging it as factually incorrect or useless. This feedback may be used by agent training framework 504 to i.) further train policy network 810 by issuing new model weights 818 and/or ii.) trigger a review process of the actions performed by troubleshooting agent 502, as they may include a bug or have mismatching description and implementation. In such a case, agent training framework 504 may provide a new action 816a for selection by policy network 810, from this review process.

In general, agent training framework 504 is concerned with the improvement of the performance of troubleshooting agent 502 over time. To this end, agent training framework 504 may include a sub-component, referred to herein as a “troublemaker,” that allows agent training framework 504 to generate new scenarios with an explicit reward provided by an evaluation framework that grades the answers of the agent.

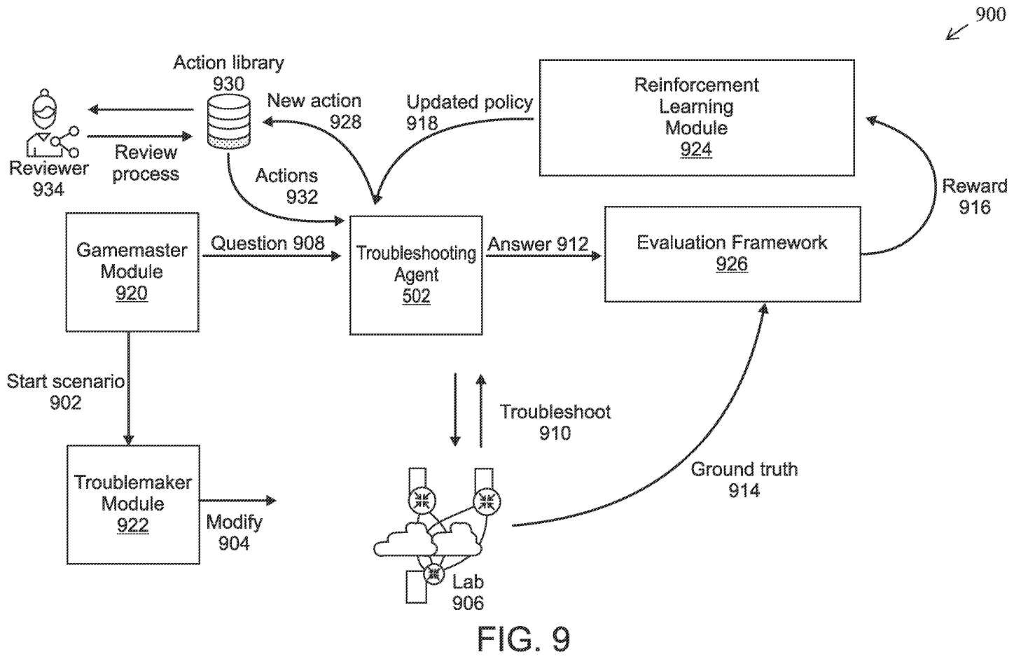

FIG. 9 illustrates an example architecture for agent training framework 504, in various embodiments. As shown, agent training framework 504 may include various subcomponents, such as a gamemaster module 920, a troublemaker module 922, a reinforcement learning module 924, and/or an evaluation framework 926. As shown, gamemaster module 920 may initiate a game by sending an instruction 902 to troublemaker module 922 to start a new scenario for a new test case.

In turn, troublemaker module 922 may send one or more messages 904 into the network 906, which is preferably a sandbox/lab environment, to instantiate the scenario. Next, gamemaster module 920 may issue a corresponding question 908 to troubleshooting agent 502 regarding the scenario, asking it to perform a task such as troubleshooting the scenario, retrieving certain information that pertains to the scenario, or even devise actions to correct the scenario.

By way of example, troubleshooting agent 502 may perform troubleshooting 910 by interfacing with one or more services or devices in network 906, to generate an answer 912 using its LLM(s), which it provides to evaluation framework 926 for analysis. Similarly, evaluation framework 926 may obtain ground truth information 914 regarding the scenario from network 906 and compare it to answer 912, to determine whether troubleshooting agent 502 was able to successfully address question 908. Based on this comparison, evaluation framework 926 may compute a reward 916 that it provides to reinforcement learning module 924. Based on the computed reward, reinforcement learning module 924 may opt to compute a new updated policy 918 for troubleshooting agent 502 (e.g., of policy network 810), to improve its functionality. In some cases, reinforcement learning module 924 may also provide the reward 916 back to gamemaster module 920 to determine the next game to perform and its difficulty.

More specifically, a game may consist in gamemaster module 920 instructing troublemaker module 922 to perform some (malicious) changes to the network (e.g., a scenario) and asking troubleshooting agent 502 to either 1.) pinpoint the root cause or 2.) fix the issue altogether. Note that a given scenario (e.g., a flapping switch port) can lead to multiple games of increasing difficulty depending on the question asked gamemaster module 920. For instance, in the case of the scenario relating to a flapping switch port, various games related to this scenario may entail asking troubleshooting agent 502 to answer any of the following questions, which increase with difficulty:
Is port X of switch Y flapping?
Which port of switch Y is flapping?
Is there a switch port flapping?
There is a problem with switch Y, which one?

A key factor driving the difficulty of the scenario is the harmfulness of the generated impairment and, therefore, how easy it is to detect. Indeed, gamemaster module 920 may initiate scenarios with minor impairments to the network (e.g., by starting by injecting small error rates, a few link flaps in the network, or on the contrary, very strong impairments such as high rates of link flaps, error rate, node reboots, etc.) and increasing gradually the magnitude of these impairments.

Questions that gamemaster module 920 may send to troubleshooting agent 502 during any game may take any or all of the following:

1. Troubleshooting questions such as:
User X sees packet loss to host 1.2.3.4. Can you determine why?
User X has trouble connecting to Webex. Can you determine why?

2. Requests to perform certain actions such as:
User X is complaining about poor Webex experience. Can you please fix the issue?

3. Requests to perform certain analyses, such as:
Can you provide me the list of all users impacted by the same issue as X?

As would be appreciated, while the input to troubleshooting agent 502 from gamemaster module 920 is generally referred to herein as a “question,” any such input may also take the form of a statement or other request and does not necessarily need to be in question form. Thus, as used herein, the term “question” is intended to be encompassing of these alternatives and refer generally to any input request for troubleshooting agent 502 during any given test/game.

In some implementations, troubleshooting agent 502 can also extend a question with hints, providing observations about the network that troubleshooting agent 502 can leverage directly (e.g., user X is connected to device Y, etc.).

As will be appreciated, the same network scenario may be associated with a wide range of games and difficulties. To this end, gamemaster module 920 may use a generative model, as well, to generate the following:
1. Scenario definition: which determines what the Troublemaker must execute. This may, for instance, take the form of a YAML file.
2. The question that the troubleshooting agent must answer.

Both of the above can be generated by gamemaster module 920 using an LLM, for instance, possibly with some generation constraints (e.g., for a YAML file). In some embodiments, gamemaster module 920 may select the scenario definition from a list of pre-defined scenarios. In other embodiments, troubleshooting agent 502 may simply modify pre-defined scenarios (e.g., by changing the circuit or device impacted). In more advanced embodiments, gamemaster module 920 may generate the whole scenario from scratch based on a known set of impairment capabilities of troublemaker module 922.

As part of this learning process, new actions can also be generated for use by troubleshooting agent 502. For instance, a subject matter expert (SME) reviewer 934 may perform a review process with respect to action library 930 and define and/or approve new actions 928 for inclusion in the set of actions 932 allowable by troubleshooting agent 502.

There are two key things that agent training framework 504 can adjust, to improve the performance of troubleshooting agent 502:
The actions which troubleshooting agent 502 can execute. As noted, these may take the form of a set of Python functions (or in another suitable language) produced either manually by an expert, or automatically by a coding LLM (e.g., WizardCoder, etc.). Regardless of whether they are generated automatically or specified by an SME, the actions may also be subject to some testing, such as by executing them against a real network (e.g., network 906) and validating their output. Furthermore, they may also undergo a peer review process before making their way into the so-called revision of the action set.
The policy which governs which action is executed at each step, which may be a standard LLM prompted to select the next action or another type of model and drives the entire process of troubleshooting.

Multiple strategies can be used to improve the actions, such as the following:
Analyzing the execution traces of troubleshooting agent 502 can uncover faulty actions (e.g., low, or very low success rate of traces that use them, or increased token usage of these traces due to retries).
Cross-validation of their output with similar or correlated actions (e.g., if an action produces the IP address of a device, trying to use this IP address to fetch data about the said device can uncover an issue).

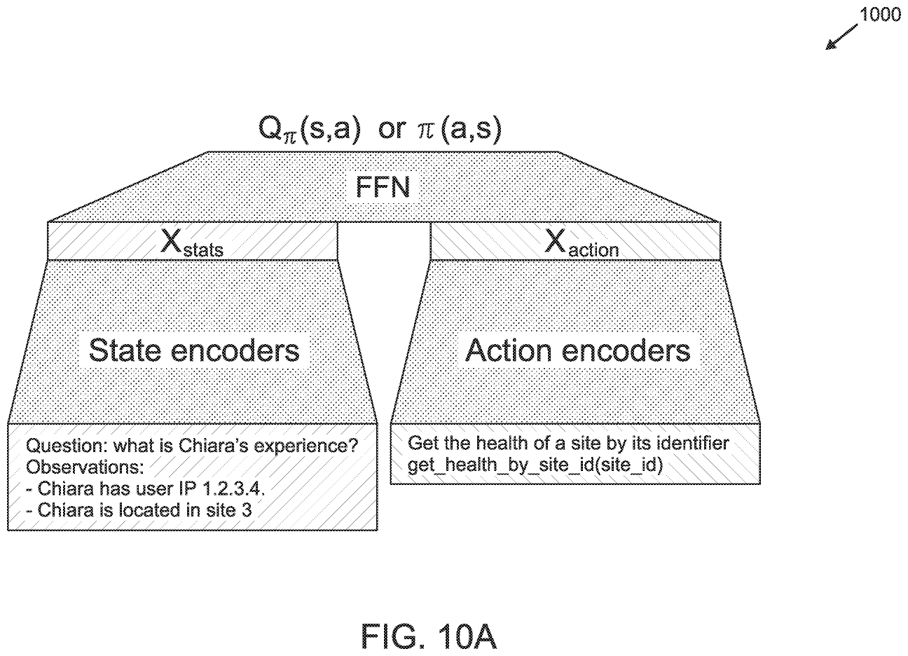

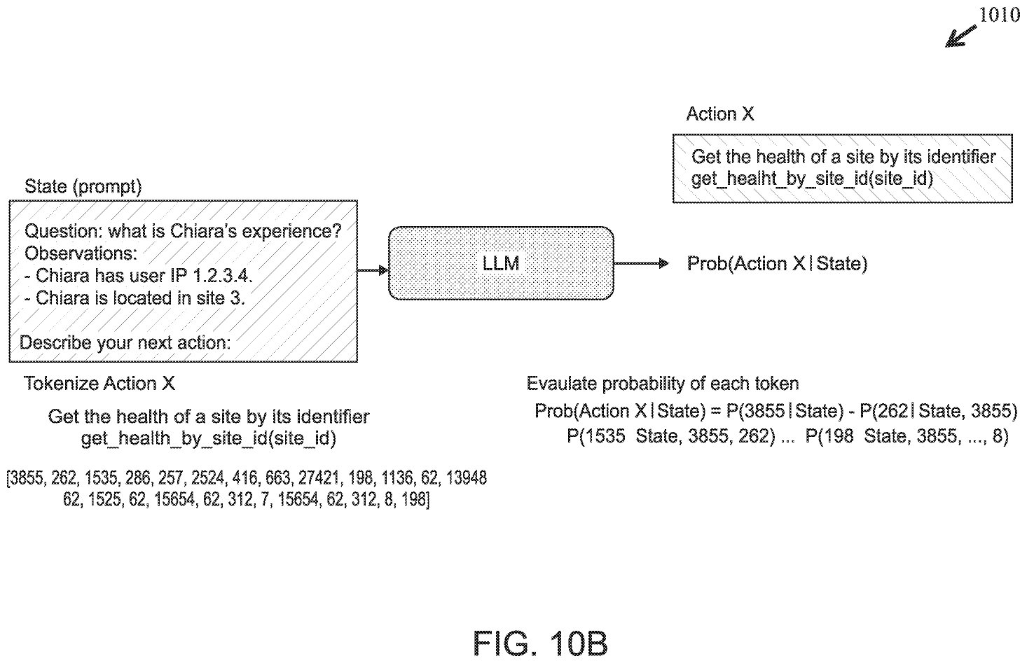

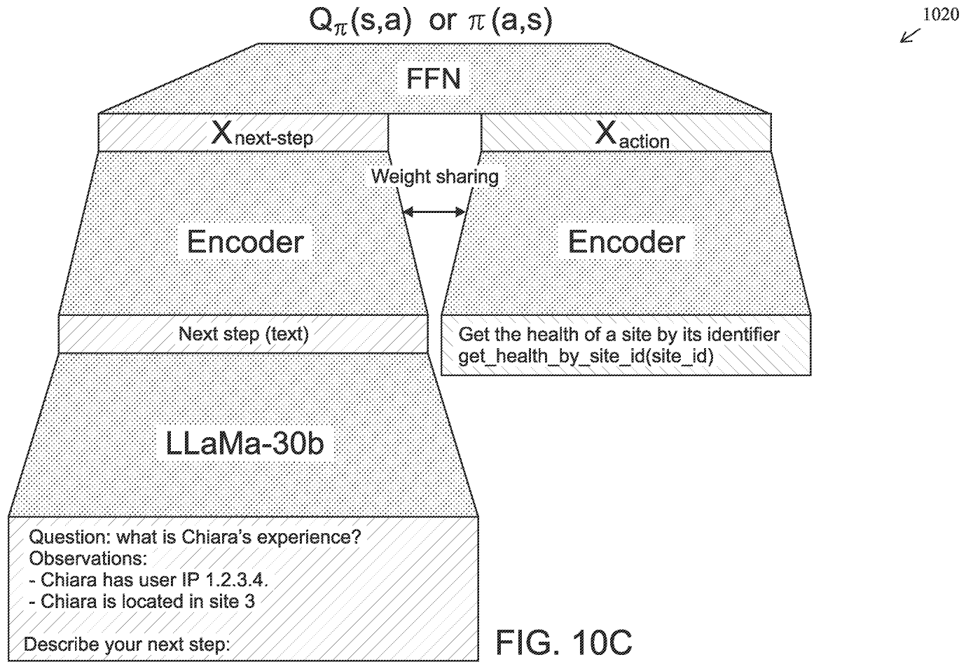

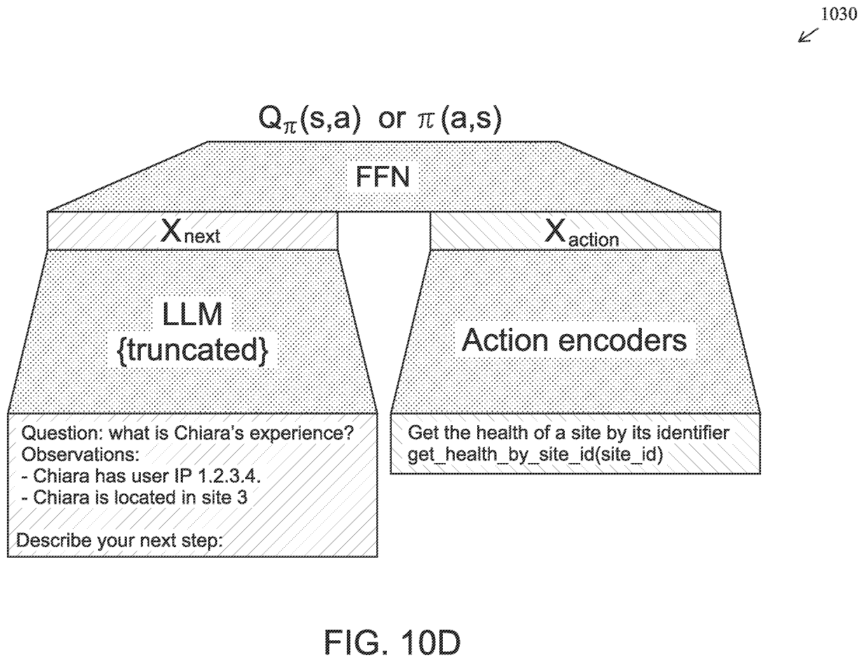

FIGS. 10A-10D illustrate example policy strategies, in various implementations. As would be appreciated, policy network 810 used by troubleshooting agent 502 can have a diverse set of architectures, but it always relies on a transformer-based architecture as its input is, one way or the other, textual.

In one implementation, policy network 810 may use an architecture that relies on an LLM with retrieval augmented generation (RAG). This is the first and simplest strategy that consists in prompting a pre-trained (instruct) model such as GPT-4 or LLaMa2, combined with a RAG strategy, to select the next action. In itself, this is a form of a reinforcement learning policy, which can be, in principle, trained to optimize the cumulative reward like any other strategy. The main benefits of this approach are simplicity, flexibility (prompting only, possibly using few-shot learning such as in-context learning), and explainability (e.g., one can prompt the LLM to explain its choice). On the downside, though, this approach does not support combined end-to-end fine-tuning of the LLM and RAG. There is also no principled way to train this policy using reinforcement learning, as it chooses actions in a greedy fashion, without outputting a score (Q value) or a probability (π).

FIG. 10A illustrates a second potential architecture 1000 for policy network 810, which relies on two encoders. In this architecture, both the state and the actions are embedded using two encoder models (e.g., BERT-like) and produce two embeddings xstate and xaction, which can be concatenated and fed to a Feed-forward Neural Network (FNN) responsible for scoring the (action, state) pair. This scoring can either be a Q-value (if trained using Q-learning) or possibly be normalized across all actions using a softmax in order to produce a proper policy π(α, s) (e.g., trained using policy gradients or proximal policy optimization). The benefits to this approach are its simplicity, it is lightweight, and is trainable end-to-end. However, encoders also have limited capacity, both in context size and capability, so they are unlikely to capture planning strategies that we require in our use case. There is also limited explainability using this approach and would require a surrogate model.

In another implementation, policy network 810 my use architecture 1010 shown in FIG. 10B, whereby an LLM is used with a corresponding policy. In this approach, the LLM computes the likelihood of each action directly, token by token. The main benefits of this is its conceptual simplicity and it is trainable end-to-end. However, there is also a higher inference cost, limited explainability, and the potential for a conceptual mismatch between a sequence probability and the intent. For instance, the action ‘Get the IP address (e.g., 127.1.2.3) of a switch in DNAC’ might be assigned a lower probability than ‘Get the MAC address of a switch in DNAC,’ although the intent was indeed to get the MAC address, because the probability of the tokens in the chain ‘127.1.2.3’ is very low.

FIG. 10C illustrates another example architecture 1020 for policy network 810 that leverages both encoders and an LLM, in another implementation. This architecture is somewhat like the LLM+RAG one above, but instead of providing the candidate actions in the prompt and asking the LLM to choose one. The system scores the embeddings of (next_action, action), whereby next_action is generated by the LLM and embedded using the same model as the actions. The main benefits of this approach are that each model can be trained separately and the flexibility to adjust the prompt of the LLM for increased performance. However, this approach also does not afford end-to-end fine-tuning (we would need to differentiate through the decoding loop), but an ability to train a feed-forward neural network (FFN) using reinforcement learning. In addition, it is possible that this approach could provide limited explainability, although explainability may still be possible by extracting a subset of the model output to build next_action.

In another implementation, FIG. 10D illustrates an example architecture 1030, which is a step towards using an LLM as a General Pattern Machine. The idea here is to use an LLM to produce an embedding instead of a token and score the pair (xstate, xaction) using an FFN, which would essentially ‘match’ the embedding produced by the LLM, which represents a latent intent, with an action. This approach affords end-to-end training, both on demonstrations and using reinforcement learning. It also affords high inference speeds (the LLM produces only one “token”) and flexibility to adjust the prompt of the LLM. However, this approach also entails more complex training, needs adaption of an off-the-shelf model, and offers limited explainability (need for a surrogate model).

With respect to collecting rewards and training the policy, agent training framework 504 may perform the training in two distinct phases, like AlphaGo:
Supervised pre-training: here, agent training framework 504 may first collect traces from previous runs that were successful. These traces consist of (action, state) pairs with a known ‘value’:
   Implicit value: here, the system may assume that pairs chosen by a reliable source (i.e., a very capable model from which we can perform distillation or an expert) have an intrinsic value.
   Explicit value: here, the system may ask troubleshooting agent 502 to rate its choice a posteriori, given the observation that it collected. The system may also factor in at this point the eventual reward, i.e., whether the chain produced the correct answer.

Agent training framework 504 then fine-tunes the policy based on such pairs. The training strategy may differ depending on the architecture, but it always consists in performing some form of loss backpropagation.
Reinforcement learning: given a pre-trained policy, agent training framework 504 then executes troubleshooting agent 502 on a vast number of “games” set up by gamemaster module 920 and troublemaker module 922, and collects the reward R. Each game can also be executed multiple times, sampling different actions from the policy or from the large language models used to trigger function calls and to produce the final answer, allowing for more exploration. The value of R can either be binary (success or failure) or a score that is proportional to how accurate or useful the answer is. Then, agent training framework 504 may update the policy by using an appropriate algorithm, such as any of the following:
   Policy-based (e.g., Proximal Policy Optimization (PPO))-if the model produces a direct policy, i.e., a probability distribution over the actions.
   Value-based (e.g., Q-Learning)-if the model produces a score, which leads to a policy by choosing the action of maximal value.
   Actor-Critic methods use a combination of both strategies, but they require two models: i.) a policy network, called the Actor, which produces a probability distribution, and ii.) a value network, called the Critic, evaluates the actions chosen by the Actor. The Actor is trained based on the estimates provided by the Critic, which, in turn, is trained using actual rewards from the environment. This strategy can help stabilizing the learning process of both networks, as well as learn to take better actions in different states.
Validating Reusable Code for a Language Model-based Network Agent

As noted above, a mechanism is introduced herein that allows for a language model-based network agent to learn over time how to perform certain tasks, such as troubleshooting issues in a computer network. This functionality is prefaced on the agent using its language model to generate executable code that can perform certain actions, such as querying a network controller or other entity in the network for specific information. The agent may use a single action to do so or stitch together several actions into a sequence, to perform complex networking tasks. Such code can be generated automatically but could also be provided in some instances by an expert user.

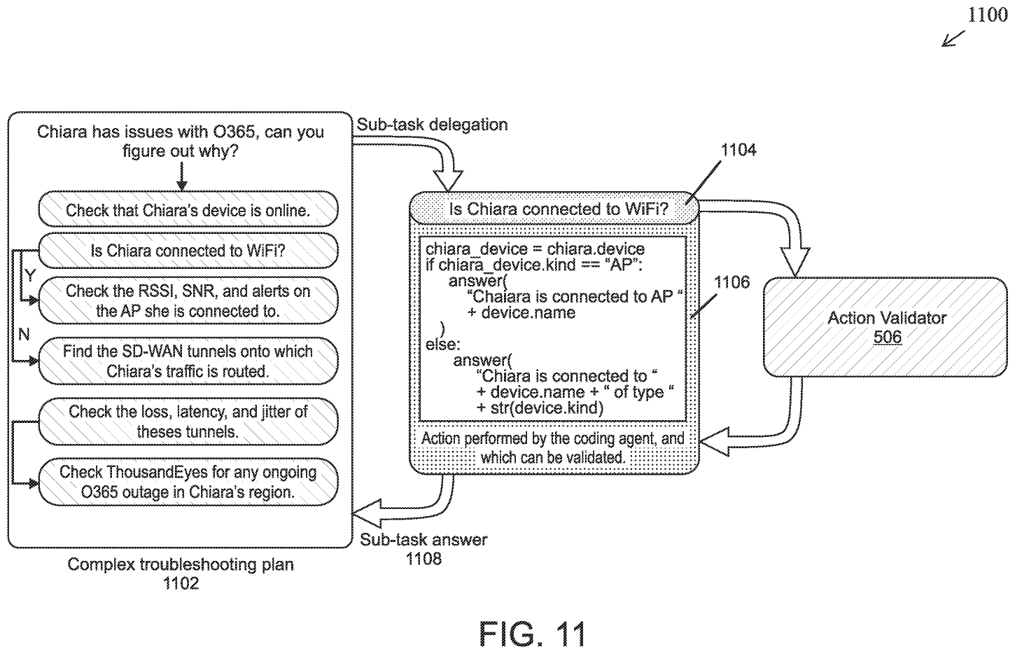

FIG. 11 illustrates an example of a language model-based network agent, such as troubleshooting agent 502, generating code to perform an action. As shown, assume that troubleshooting agent 502 has received the question “Chiara has issues with O365, can you figure out why?” In response, troubleshooting agent 502 may first formulate a complex troubleshooting plan 1102 that comprises the set of actions that it needs to take to arrive at an answer. For instance, such actions may include checking that Chiara's device is online, determining whether that device is connected to Wi-Fi, checking the wireless signal properties of that connection if it exists, finding the SD-WAN tunnels onto which Chiara's traffic is routed, checking the path metrics for those tunnels (e.g., loss, latency, and jitter), checking ThousandEyes for any ongoing O365 outages in Chiara's region, etc.

To perform these sub-tasks/actions, troubleshooting agent 502 may even delegate them to a specialized agent, such as a coding agent configured to generate code to perform that action and provide an answer for the sub-task. For instance, consider the action of determining whether Chiara's device is connected to Wi-Fi. In such a case, troubleshooting agent 502 may make a sub-task delegation 1104 to a coding agent to generate code 1106 that, when executed, outputs an answer 1108 indicative of whether Chiara's device is connected to a Wi-Fi access point (AP) and, if so, which one and its type.

Regardless of how the code to perform a given action is generated, validation of it can help to prevent the system from making mistakes. As will become clearer later, the “status” of validation (work-in-progress vs. validated) may then be applied to the (coding agent, task) pair, i.e., it validates the coding agent is trustworthy for this type of tasks. Optionally, one can perform a validation on-the-fly for each occurrence of the task or a random sample thereof, depending on the criticality of the task. For instance, as shown in FIG. 11, action validator 506 may perform a validation assessment on code 1106.

According to various implementations, the techniques herein provide for validating the factuality of new code to perform an action by cross-checking their output with existing similar or correlated validated actions (which were either produced by an expert user or language model-produced actions that were previously validated). For example, if an action retrieves an IP address or a MAC address through execution of its associated code, actions that use those as inputs are then executed and their output is verified to be consistent. Other techniques such as producing or executing the opposite action may also be leveraged. For instance, if an action finds the site where a particular user is connected (e.g., “Chiara is in Site-A”), action validator 506 may validate the results against an action that lists all users in that site (e.g., “List all users in Site-A”), which should include the initial user. Additionally, action validator 506 also allows checking whether literals such as IP, MAC addresses, host names, and serials are not hallucinated.

In various implementations, this validation approach also allows for the storage of validated code for future use to perform an action of the same type. By reusing validated code, this allows the agent to generate responses more quickly and conserve computing resources, as generating code each time can be computationally intensive and time consuming.

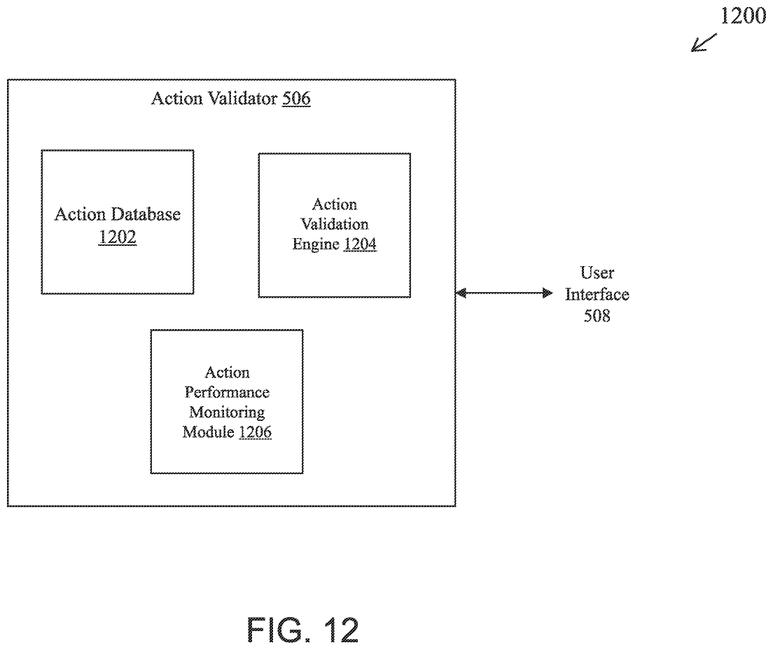

FIG. 12 illustrates an example architecture 1200 for validating code generated by a language model-based agent. As shown, action validator 506, itself a component of language model process 249, may include any or all of the following sub-components: an action database 1202, an action validation engine 1204, and/or an action performance monitoring module 1206. As would be appreciated, the functionalities of these components may be combined or omitted, as desired. In addition, these components may be implemented on a singular device or in a distributed manner, in which case the combination of executing devices can be viewed as their own singular device for purposes of executing action validator 506.

According to various implementations, action database 1202 may be responsible for storing all available actions for which code was already generated. To this end, each record in action database 1202 may include any or all of the following information:
ActionId: unique action identifier (e.g., d851ce3057)
Status:
   New: a new action that is pending validation
   Rejected: has undergone validation and has been rejected
   Validated: has been successfully validated
   Duplicate: a duplicate of an already existing action
Name: function name, (e.g., get_top_colors_by_bytes)
Description: description of function role (e.g., what is the function supposed to do)
InputParameters: list of input parameters
OutputParameters: list of output parameters
Code: the generated function code to perform the action
Source: action source (LLM, subject matter expert, software development kit, etc.)
RejectionReason: a human-readable description of why the action was rejected, if rejected
RelatedActions: this field lists actions that are related to the current one and which can be used to validate the action output factuality. For example: if an action finds the device where a particular user is connected (e.g., Chiara is in Site-A), action validator 506 may validate the results against an action that lists all users in that site (e.g., List all users in Site-A), which should include the initial user.

In various implementations, actions may be submitted to action database 1202 from different sources, such as either or both of the following:
1. Expert user-sourced: actions may be created directly by human subject matter experts (SMEs) with domain expertise. SME actions are expected to only account for a small portion of the overall actions. However, they may be crafted either at the initial deployment of the system to seed the database or after reviewing the traces from troubleshooting agent 502, to resolve frequent failures (e.g.: an action enabling the agent to solve a frequent task which would otherwise always fail). It can also be assumed that expert-created actions are validated end to end.
2. Language model-sourced: as described previously, an agent may leverage the zero-shot capabilities of complex models, such as LLMs, or few-shot with some examples, to generate the code to perform certain actions in a network. It is expected that this is the primary way for the system to learn new actions over time. For instance, troubleshooting agent 502 may generate logs for each run, whether from a real user question, or a scenario question (e.g., question 908 produced by gamemaster module 920 in FIG. 9). The logs are referred to as traces and contain the details of the task employed (e.g.: “Find IP address of user John.”) and the corresponding code to perform the actions to complete the task. More complex questions may require a first step that consists of formulating a plan in natural language, and subsequent steps in executing this plan by writing code to call APIs or libraries, with each step corresponding to an action. As an optional step, actions extracted from agent traces may undergo a generalization step. Actions extracted from the agent traces are submitted to action database 1202 in new state.
3. API/SDK: native software development kit (SDK) methods or API endpoints may also be used as another way to seed the initial action database 1202. Given that these methods are known to be working, they can be submitted to action database 1202 directly in a validated state.

In some implementations, action database 1202 can take the form of a vector database, such as Chroma or Pinecone, with the action code and description information being stored as vector embeddings, while the remaining fields are stored as metadata. In one embodiment, action database 1202 may generate the embeddings using a SaaS service, such as the one provided by OpenAI, where the action code and description are sent via an API interface to a cloud service that returns the vector embedding. In another embodiment, action database 1202 can make use of one of the pre-trained, open-source embedding models to generate the vector embeddings locally.

In various embodiments, action validation engine 1204 may be responsible for validating the output of any new actions added to action database 1202 using several mechanisms.

First, action validation engine 1204 may try to determine whether the new action under test (AUT) is a duplicate of an existing one by performing a semantic search of action database 1202 for related actions (e.g., based on action code and description). Action validation engine 1204 may set the duplicate status based on one or more conditions such as:
a similarity score threshold to determine whether any existing actions may be duplicates.
an LLM model may be queried with a prompt listing the code and description of the AUT along with the top-k similar records and requested to determine whether the new function is a duplicate.
optionally, both the AUT and highly similar functions may be executed using the same set of parameters and the outputs compared.

Should the AUT be determined to be a duplicate of an existing one, action validation engine 1204 may stop the validation process and update the action database 1202 to list the action as a duplicate.

Next, action validation engine 1204 may proceed to validate the validity of the AUT result by executing it. However, to do so, action validation engine 1204 must first determine appropriate values for the action input parameter(s) of the code. For example, should the AUT take as input a username, action validation engine 1204 may first need to determine what valid username values to use (as per the test or validation environment). To achieve this, action validation engine 1204 may search action database 1202 for already validated actions that have usernames as their output. When multiple such actions exit, action validation engine 1204 may prefer top-level upstream actions (e.g., actions that themselves take no input, e.g., ‘get_all_users’) to avoid recursively having to resolve upstream action input parameters. When no upstream actions exist, an optional fallback option may be provided in the form of a static set of test variables configured by a system administrator.

Given that appropriate input values can be found, action validation engine 1204 may then execute the AUT and collect the results for each run. Action validation engine 1204 can also rely on various constrains specified by an administrator via a user interface, such as the number of executions, as each action should be run multiple times, ideally with different sets of parameters to ensure that it can run reliably.

At this stage, action validation engine 1204 may proceed to perform several verifications, such as any or all of the following:

First, action validation engine 1204 may attempt to check if the outputs from the executed code (e.g., IP addresses, hostnames, site names, site IDs, etc.) are valid. This can be accomplished using a set of predefined static rules (e.g., user IP addresses must belong to a specific subnet, hostnames must follow a specific naming format that can be verified using a regular expression, site IDs must follow a specific range, etc.). Alternatively, action validation engine 1204 may use top-level API endpoints or SDK methods that can retrieve the full list of users, sites, devices, etc. Should the output of the AUT not conform to this check, action validation engine 1204 may mark the action as rejected and update action database 1202, accordingly. Otherwise, action validation engine 1204 may proceed to the next step below.

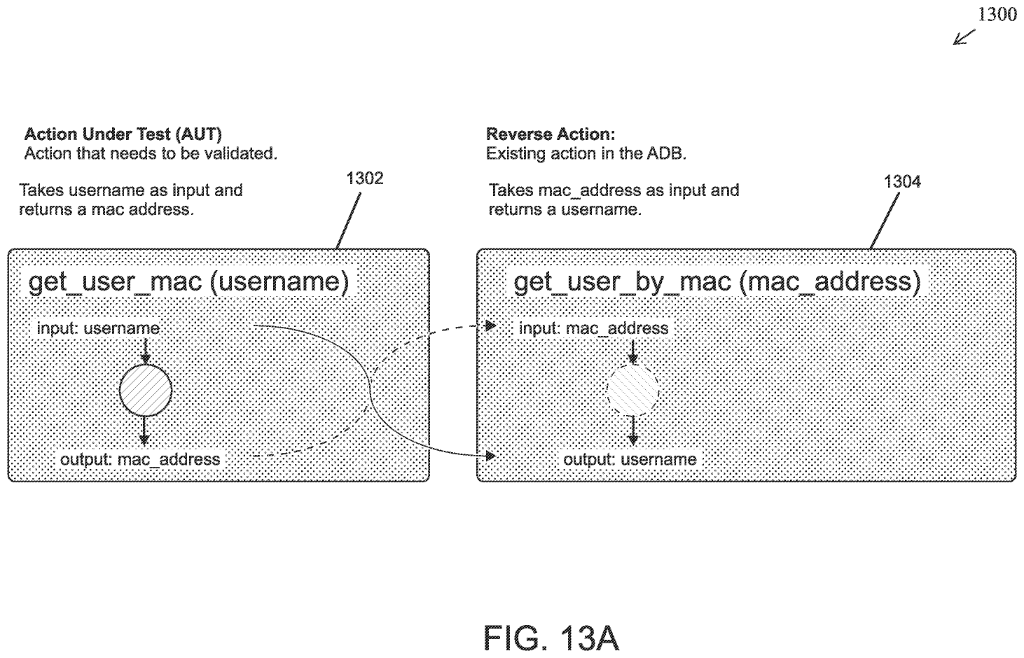

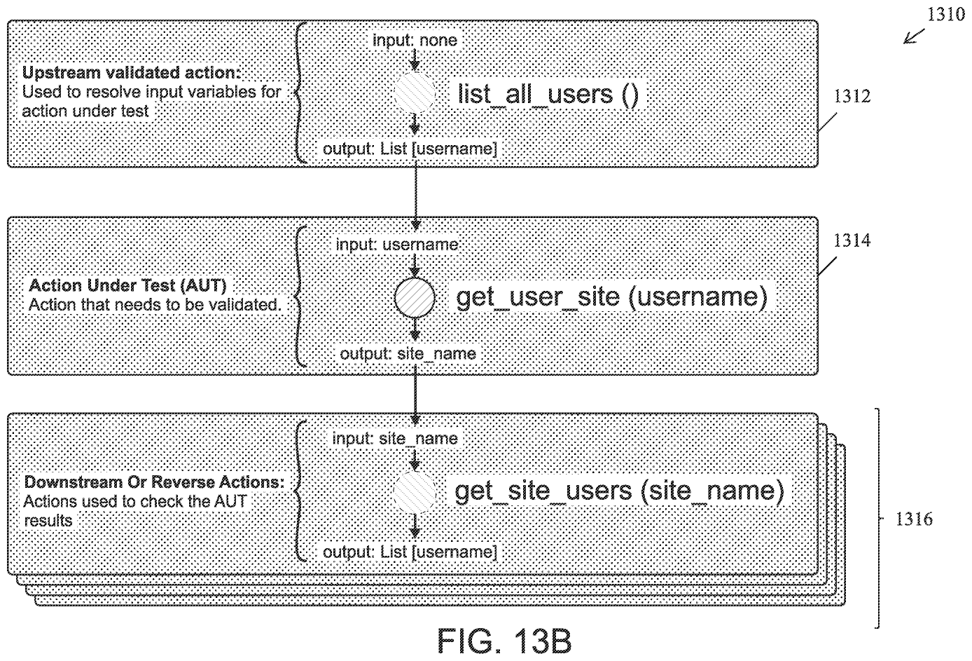

Next, action validation engine 1204 may determine whether any reverse validated actions exist in action database 1202. For example, as shown in example 1300 in FIG. 13A, the reverse of a given action 1302 that uses a function ‘get_user_by_mac,’ which takes as input a ‘mac_address’ parameter and returns a username, may be a reverse action 1304 that uses function ‘get_user_mac,’ which takes as input a username and returns its mac address. Action validation engine 1204 may use any such reverse actions that exist in the system to cross-validate the results of the new action (e.g., the output of the code associated with that action).

Optionally, should no reverse actions exist, action validation engine 1204 may attempt to employ an LLM or other language model, to create such a reverse action from scratch.

Finally, action validation engine 1204 may determine whether any downstream actions exist in action database 1202. Downstream actions take at least one input from the action under test. If any such downstream actions exist, action validation engine 1204 may proceed to run them and determine the rate of successful executions.

Example 1310 in FIG. 13B shows the concept of upstream and downstream actions employed by action validation engine 1204 to validate the AUT. Here, assume that the AUT is action 1314 which includes the function get_user_site (username), which takes as input username as a parameter and outputs site_name (e.g., the site name of that user). Here, the upstream action is action 1312, which uses function list_all_users( ) without any input parameters and outputs a list of usernames from which the input parameter for action 1314 may be selected. In addition, the downstream or reverse actions 1316 of action 1314 may include a function get_site_users that takes as input the site_name parameter (the output of the code of 1314) and returns the list of usernames for that site. Here, action validation engine 1204 may validate action 1314 by comparing the initial list of usernames from the upstream action 1312 to that of the downstream action 1316.

Referring again to FIG. 12, action validation engine 1204 may also allow an administrator or other user to specify various configuration constraints via a user interface, to configure various checks as optional or mandatory, along with allowing the definition of execution success thresholds for each step.

Finally, action performance monitoring module 1206 may interact with troubleshooting agent 502, or any other agent that leverages the reusable code, to track the performance of validated code that the agent uses to perform a given action. For instance, in the case of action validation engine 1204 validating action 1314, the agent may then look to action database 1202 for its code, to perform a subsequent action of the same type (e.g., retrieving the user site for a given user). In such a case, action performance monitoring module 1206 may assess this execution, to ensure that action 1314 successfully served its intended purposes.

For instance, action performance monitoring module 1206 may track various metrics such as any or all of the following:
Total number of executions: how many times the agent used the reusable code to perform an action of a certain type.
Percentage of code exceptions: the percentage of times the code was executed and encountered a code exception.
Percentage of success: the percentage of times the action was part of an action chain leading to the agent successfully responding to a question or performing a desired task.

Action performance monitoring module 1206 may also allow system administrators to configure thresholds for each performance metric, such that they are notified when actions fail to meet minimum performance expectations. In turn, action performance monitoring module 1206 may flag those actions for review (or directly reject them).

Finally, action validator 506 may interact with user interface 508 to allow for any or all of the following:
Action Editing: action validator 506 may provide an interface to user interface 508 that an expert user may use to create, test, and submit new actions/code snippets. Additionally, they may also use the interface to inspect, execute, or update any existing actions in action database 1202.
Performance Monitoring: action validator 506 may also provide performance metrics from action performance monitoring module 1206 for review via user interface 508. It may also flag any actions/code that do not meet minimum performance metrics for review.
System Configuration: action validator 506 may also provide an interface to user interface 508 that allows an administrator or other user to configure constraints to the system operations such as configuring the details of the validation/test environment (e.g., controller details, static test values, etc.), and setting the various control parameters for control of action validation engine 1204 and action performance monitoring module 1206 (e.g., metric thresholds).

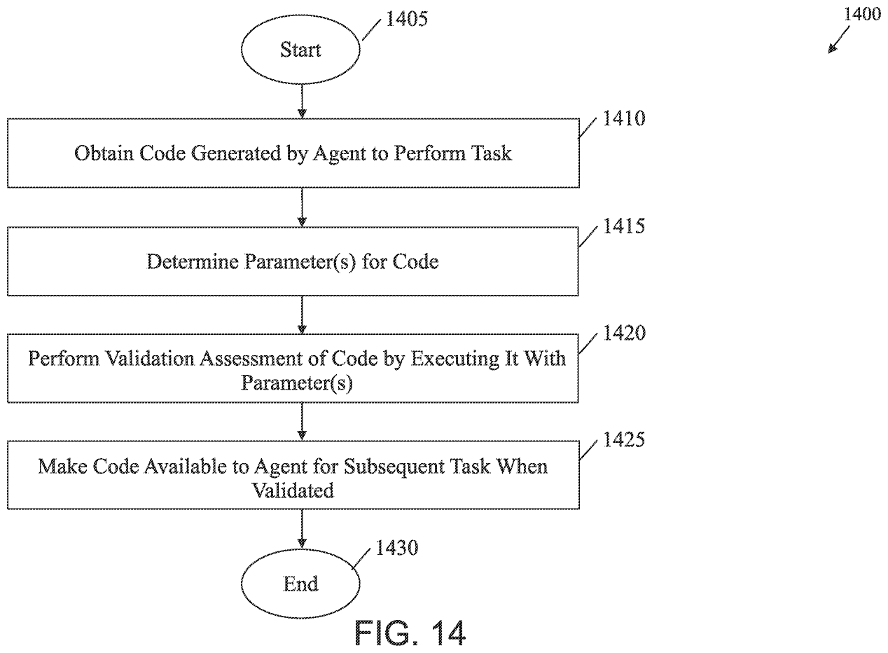

FIG. 14 illustrates an example simplified procedure 1400 (e.g., a method) for validating reusable code for a language model-based network agent, in accordance with one or more implementations described herein. For example, a non-generic, specifically configured device (e.g., device 200), such as a router, firewall, controller for a network (e.g., an SDN controller or other device in communication therewith), server, or the like, may perform procedure 1400 by executing stored instructions (e.g., language model process 249 and/or network control process 248). The procedure 1400 may start at step 1405, and continues to step 1410, where, as described in greater detail above, the device may obtain code generated by a language model-based agent to perform an action of a particular type with respect to a computer network. In various cases, the particular type of the action corresponds to one or more troubleshooting steps for a particular issue in the computer network. In some instances, the code when executed accesses an application programming interface of a network controller.

At step 1415, as detailed above, the device may determine one or more parameters to execute the code in a testing environment. For instance, the device may identify an input user name, device name, network address, or the like, that is needed to test the code in the testing environment.

At step 1420, the device may perform a validation assessment of the code to assess whether it is able to perform actions of the particular type by executing it with the one or more parameters in the testing environment, as described in greater detail above. In various implementations, the device may do so by using an output of the code from its execution in the testing environment as input to additional code configured to perform a reverse of the action of the particular type and determining whether an output of the additional code matches the one or more parameters. In some instances, the device performs the validation assessment when the code is not similar to previous code validated for use by the language model-based agent. The device may also perform the validation assessment in accordance with one or more constraints specified via a user interface.

At step 1425, as detailed above, the device may make, based on the validation assessment, the code available to the language model-based agent to perform a subsequent action of the particular type. In some instances, the device makes the code available to the language model-based agent by storing it in a database of validated code accessible by the language model-based agent. In various implementations, the language model-based agent uses the code to perform the subsequent action in lieu of generating new code to do so. The device may also provide performance metrics regarding use of the code by the language model-based agent to a user interface for review by a user.

Procedure 1400 then ends at step 1430.

It should be noted that while certain steps within procedure 1400 may be optional as described above, the steps shown in FIG. 14 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for validating reusable code for a language model-based network troubleshooting agent, it is to be understood that various other adaptations and modifications may be made within the spirit and scope of the implementations herein. For example, while certain implementations are described herein with respect to using certain models for purposes of generating CLI commands, making API calls, charting a network, and the like, the models are not limited as such and may be used for other types of predictions, in other implementations. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
obtaining, by a device, code generated by a language model-based agent to perform an action of a particular type with respect to a computer network;
determining, by the device, one or more parameters to execute the code in a testing environment;
performing, by the device, a validation assessment of the code to assess whether it is able to perform actions of the particular type by executing it with the one or more parameters in the testing environment; and
making, by the device and based on the validation assessment, the code available to the language model-based agent to perform a subsequent action of the particular type.

2. The method as in claim 1, wherein the device makes the code available to the language model-based agent by storing it in a database of validated code accessible by the language model-based agent.

3. The method as in claim 1, wherein the device performs the validation assessment when the code is not similar to previous code validated for use by the language model-based agent.

4. The method as in claim 1, wherein the particular type of the action corresponds to one or more troubleshooting steps for a particular issue in the computer network.

5. The method as in claim 1, wherein performing the validation assessment comprises:
using, by the device, an output of the code from its execution in the testing environment as input to additional code configured to perform a reverse of the action of the particular type; and
determining, by the device, whether an output of the additional code matches the one or more parameters.

6. The method as in claim 1, wherein the language model-based agent uses the code to perform the subsequent action in lieu of generating new code to do so.

7. The method as in claim 1, further comprising:
providing, by the device, performance metrics regarding use of the code by the language model-based agent to a user interface for review by a user.

8. The method as in claim 1, wherein the device performs the validation assessment in accordance with one or more constraints specified via a user interface.

9. The method as in claim 1, wherein the code when executed accesses an application programming interface of a network controller.

10. The method as in claim 1, wherein language model-based agent uses a large language model (LLM) to generate the code.

11. An apparatus, comprising:
one or more network interfaces;
a processor coupled to the one or more network interfaces and configured to execute one or more processes; and
a memory configured to store a process that is executable by the processor, the process when executed configured to:
obtain code generated by a language model-based agent to perform an action of a particular type with respect to a computer network;
determine one or more parameters to execute the code in a testing environment;
perform a validation assessment of the code to assess whether it is able to perform actions of the particular type by executing it with the one or more parameters in the testing environment; and
make, based on the validation assessment, the code available to the language model-based agent to perform a subsequent action of the particular type.

12. The apparatus as in claim 11, wherein the apparatus makes the code available to the language model-based agent by storing it in a database of validated code accessible by the language model-based agent.

13. The apparatus as in claim 11, wherein the apparatus performs the validation assessment when the code is not similar to previous code validated for use by the language model-based agent.

14. The apparatus as in claim 11, wherein the particular type of the action corresponds to one or more troubleshooting steps for a particular issue in the computer network.

15. The apparatus as in claim 11, wherein the apparatus performs the validation assessment by:
using an output of the code from its execution in the testing environment as input to additional code configured to perform a reverse of the action of the particular type; and
determining whether an output of the additional code matches the one or more parameters.

16. The apparatus as in claim 11, wherein the language model-based agent uses the code to perform the subsequent action in lieu of generating new code to do so.

17. The apparatus as in claim 11, wherein the process when executed is further configured to:
provide performance metrics regarding use of the code by the language model-based agent to a user interface for review by a user.

18. The apparatus as in claim 11, wherein the apparatus performs the validation assessment in accordance with one or more constraints specified via a user interface.

19. The apparatus as in claim 11, wherein the code when executed accesses an application programming interface of a network controller.

20. A tangible, non-transitory, computer-readable medium storing program instructions that cause a device to execute a process comprising:
obtaining, by the device, code generated by a language model-based agent to perform an action of a particular type with respect to a computer network;
determining, by the device, one or more parameters to execute the code in a testing environment;
performing, by the device, a validation assessment of the code to assess whether it is able to perform actions of the particular type by executing it with the one or more parameters in the testing environment; and
making, by the device and based on the validation assessment, the code available to the language model-based agent to perform a subsequent action of the particular type.
